(19) United States
(12) Patent Application Publication
(10) Pub. No.: US 2025/0269287 A1
(43) Pub. Date: Aug. 28, 2025

(54) ON-LINE GAMING MONITORING SYSTEMS AND USER INTERFACES

(71) Applicants: Sony Interactive Entertainment Inc., Tokyo (JP); Sony Interactive Entertainment LLC, San Mateo, CA (US)

(72) Inventors: Anthony Jed Tung, San Diego, CA (US); Hiroyuki Toki, San Jose, CA (US); Hee Gyung Sun, Burlingame, CA (US); Shoji Watanabe, Burlingame, CA (US); Michelle E. Johnsen, Verona, WI (US); Snigdha Sah, Emeryville, CA (US); Lei Wang, San Diego, CA (US); Agus Santoso Lie, San Diego, CA (US); Issei Asano, Tokyo (JP)

(21) Appl. No.: 18/585,970

(22) Filed: Feb. 23, 2024

(51) Int. Cl. A63F 13/79; A63F 13/87

(52) U.S. Cl. CPC A63F 13/79; A63F 13/87

(57) ABSTRACT

Systems and methods described herein include a video gaming server configured to communicate with a video gaming device of a first user. A risk module is coupled to the video gaming server. The risk module is configured to: monitor online activities of the first user when the first user operates the video gaming device; determine that the first user has encountered an online risk while operating the video gaming device; and cause a notification of the online risk to be sent to a second device operated by a second user, the first and second users being associated with each other by a common account. The notification presents the second user with one or more options for responding to the online risk encountered by the first user.

### TECHNICAL FIELD

This invention relates generally to monitoring systems, and, more specifically, to systems and user interfaces for monitoring online video game play of one or more users.

### BACKGROUND

Online gaming has become increasingly popular among children, providing them with opportunities for entertainment, social interaction, and skill development. However, it is essential to be aware of the potential risks associated with online gaming. One significant risk is exposure to inappropriate content, such as violence or explicit language, which can negatively impact a child's behavior and well-being. Another concern is online predators who may exploit children's vulnerabilities. Additionally, excessive gaming can affect academic performance, physical health, and social interactions. It is crucial for parents to establish clear guidelines, monitor online activities, and promote a healthy balance between gaming and other activities to ensure a safe and positive gaming experience for children.

### SUMMARY

In some embodiments, a method includes monitoring online activities of a first user that is operating a first device, wherein the first device is a video gaming device, determining that the first user has encountered an online risk while operating the video gaming device, and sending a notification of the online risk to a second device operated by a second user, the first and second users being associated with each other by a common account. The notification presents the second user with one or more options for responding to the online risk encountered by the first user.

In one aspect, the online risk comprises an interaction of the first user with a third user, the interaction including at least one of a message, an image, a video, or an audio.

In some implementations, the determining that the first user has encountered an online risk includes detecting that an interaction between a third user and the first user violates one or more permissions or restrictions pre-set by the second user for the first user.

In certain embodiments, the determining that the first user has encountered an online risk includes feeding information relating to online activity of the first user while the first user is operating the video gaming device into an artificial intelligence model trained to recognize the online risk to the first user.

In some aspects, the one or more options presented to the second user for responding to the online risk encountered by the first user include one or more of: blocking a third user, reporting the third user, flagging the third user, sending a message to the third user, viewing online activity of the first user in real time, modifying the online activity of the first user in real time, sending a message to the first user, viewing recorded online activity of the first user, monitoring for more information regarding the online risk, modifying one or more permissions or restrictions for the online activity of the first user, or ignoring the online risk.

In one embodiment, the notification further includes a description of the online risk and/or content associated with the online risk.

In some implementations, the notification is transmitted from a video gaming server to a mobile application installed on the second device, and the notification is displayed within a graphical interface generated by the mobile application.

In some embodiments, a system includes a video gaming server configured to communicate with a video gaming device of a first user and a risk module coupled to the video gaming server. The risk module is configured to: monitor online activities of the first user when the first user operates the video gaming device; determine that the first user has encountered an online risk while operating the video gaming device; and cause a notification of the online risk to be sent to a second device operated by a second user, the first and second users being associated with each other by a common account. The notification presents the second user with one or more options for responding to the online risk encountered by the first user.

In certain embodiments, a non-transitory computer readable storage medium stores one or more computer programs which, when executed, execute steps comprising: in response to receipt of a communication indicating that a first user operating a video gaming device has encountered an online risk, displaying a notification of the online risk on an electronic device associated with a second user, the first and second users being associated with each other by a common account; displaying on the electronic device associated with the second user one or more options for responding to the online risk encountered by the first user; and sending by the electronic device associated with the second user the one or more options selected by the second user to a video gaming server that at least partially controls online activity of the first user while operating the video gaming device.

A better understanding of the features and advantages of various embodiments of the present invention will be obtained by reference to the following detailed description and accompanying drawings which set forth illustrative embodiments of the invention.

### BRIEF DESCRIPTION OF THE DRAWINGS

Disclosed herein are embodiments of systems, user interfaces, and methods pertaining to monitoring and/or managing online video game play of one or more users. This description includes drawings, wherein:

FIG. 1 is a diagram of a system of monitoring online video game play of one or more users in accordance with some embodiments;

FIG. 2 is a functional diagram of an exemplary video gaming server usable with the system of FIG. 1 in accordance with some embodiments;

FIG. 3 depicts an electronic communication device displaying a graphical user interface generated by an application executable on the electronic communication device and configured to permit a user of the electronic communication device to monitor online video gaming activities of one or more users linked to the user of the electronic communication device by a common account in accordance with some embodiments;

FIG. 4 depicts the electronic communication device of FIG. 3, displaying an interactive menu of the graphical user interface generated by the application in response to a user interaction with the graphical user interface of FIG. 3 in accordance with some embodiments;

FIG. 5 depicts the electronic communication device of FIG. 3 displaying an interactive menu of the graphical user interface generated by the application in response to a user interaction with the graphical user interface of FIG. 4 in accordance with some embodiments;

FIG. 6 depicts the electronic communication device of FIG. 3 displaying an interactive menu of the graphical user interface generated by the application in response to a user interaction with the graphical user interface of FIG. 5 in accordance with some embodiments;

FIG. 7 depicts an electronic communication device displaying a graphical user interface generated by an application executable on the electronic communication device and configured to permit a user of the electronic communication device to monitor online video gaming activities of one or more users linked to the user of the electronic communication device by a common account in accordance with some embodiments;

FIG. 8 depicts the electronic communication device of FIG. 7 displaying an interactive menu of the graphical user interface generated by the application in response to a user interaction with the graphical user interface of FIG. 7 in accordance with some embodiments;

FIG. 9 depicts an electronic communication device displaying a graphical user interface generated by an application executable on the electronic communication device and configured to permit a user of the electronic communication device to monitor online video gaming activities of one or more users linked to the user of the electronic communication device by a common account in accordance with some embodiments;

FIG. 10 depicts the electronic communication device of FIG. 9 displaying an interactive menu of the graphical user interface generated by the application in response to a user interaction with the graphical user interface of FIG. 9 in accordance with some embodiments;

FIG. 11 depicts the electronic communication device of FIG. 9 displaying an interactive menu of the graphical user interface generated by the application in response to a user interaction with the graphical user interface of FIG. 10 in accordance with some embodiments;

FIG. 12 depicts an electronic communication device displaying a graphical user interface generated by an application executable on the electronic communication device and configured to permit a user of the electronic communication device to monitor online video gaming activities of one or more users linked to the user of the electronic communication device by a common account in accordance with some embodiments;

FIG. 13 depicts the electronic communication device of FIG. 12 displaying an interactive menu of the graphical user interface generated by the application in response to a user interaction with the graphical user interface of FIG. 12 in accordance with some embodiments;

FIG. 14 depicts the electronic communication device of FIG. 12 displaying an interactive menu of the graphical user interface generated by the application in response to a user interaction with the graphical user interface of FIG. 13 in accordance with some embodiments;

FIG. 15 depicts the electronic communication device of FIG. 12 displaying an interactive menu of the graphical user interface generated by the application in response to a user interaction with the graphical user interface of FIG. 14 in accordance with some embodiments;

FIG. 16 depicts an electronic communication device displaying a notification generated by an application executable on the electronic communication device and configured to permit a user of the electronic communication device to monitor online video gaming activities of one or more users linked to the user of the electronic communication device by a common account in accordance with some embodiments;

FIG. 17 is a flow diagram representative of a method of monitoring online video game play of one or more users in accordance with some embodiments.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems and methods described herein include a video gaming server configured to communicate with a video gaming device of a first user. A risk module is coupled to the video gaming server. The risk module is configured to: monitor online activities of the first user when the first user operates the video gaming device; determine that the first user has encountered an online risk while operating the video gaming device; and cause a notification of the online risk to be sent to a second device operated by a second user, the first and second users being associated with each other by a common account. The notification presents the second user with one or more options for responding to the online risk encountered by the first user.

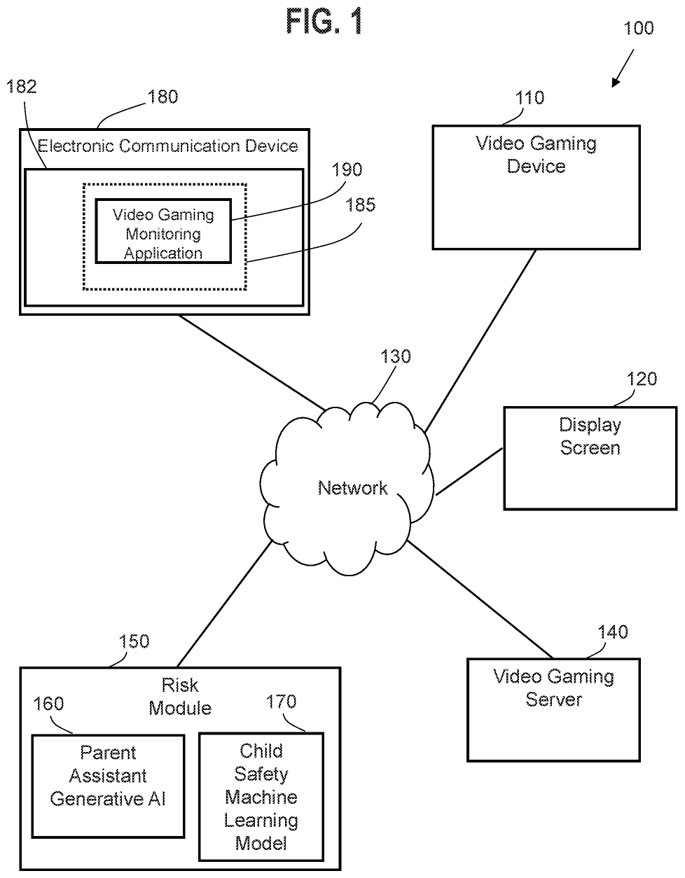

FIG. 1 shows an exemplary embodiment of a system 100 for monitoring online video game play of one or more users. The exemplary system 100 shown in FIG. 1 includes a video gaming device 110 (which may be one or more computing devices as pointed out below) operatively coupled/connected to a display screen 120 and configured to communicate over a network 130 (e.g., a wired or wireless connection) with the display screen 120. The exemplary system 100 further includes a video gaming server 140, which permits gamers to use their respective video gaming devices 110 to play video games online together over the network 130, and which enables users (e.g., parents, guardians, etc.) to monitor this online gaming, restrict exposure of the gamers to online risks, and/or address/eliminate any active online risks.

The exemplary network 130 depicted in FIG. 1 may be a wide-area network (WAN), a local area network (LAN), a personal area network (PAN), a wireless local area network (WLAN), Wi-Fi, Zigbee, Bluetooth (e.g., Bluetooth Low Energy (BLE) network), or any other internet or intranet network, or combinations of such networks. Generally, communication between various electronic devices of system 100 may take place over hard-wired, wireless, cellular, Wi-Fi or Bluetooth networked components or the like. In some embodiments, one or more electronic devices of system 100 may include cloud-based features or services, such as cloud-based memory storage, cloud-based machine learning models/neural networks, etc.

The video gaming device 110 may be a stationary or portable electronic device, for example, a stationary gaming console, a portable gaming console, a desktop computer, a laptop computer, a tablet, a mobile phone, a single server or a series of communicatively connected servers, or any other electronic device including a control circuit that includes a programmable processor and may be coupled/connected to the display screen 120. In some embodiments, the video gaming device 110 is configured for running video games thereon (e.g., from a disc inserted into the video gaming device 110, from an onboard memory of the video gaming device 110, from a remote server/host, etc.). The video gaming device 110 may be configured for data entry and processing and for communication with other devices of the system 100 via the network 130.

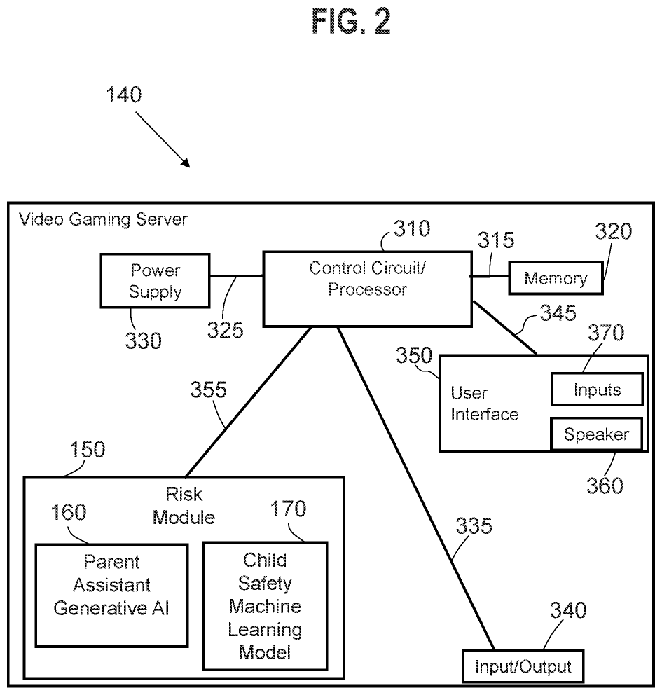

The exemplary system 100 further includes a risk module 150, which may be a stand-alone physical device (or multiple devices) as shown in FIG. 1, or may be incorporated (e.g., embedded) into the video gaming device 110 and/or the video gaming server 140 (an embodiment of an exemplary video gaming server 140 incorporating the risk module 150 is shown in FIG. 2). In the illustrated embodiment, the risk module 150 includes or is coupled to a generative artificial intelligence (AI) component 160, as well as a child safety machine learning model 170.

Generally, the term generative AI component 160 refers to a module or algorithm within an AI system that is capable of creating new content (e.g., text, images, music, etc.) based on patterns and examples it has been trained on. Unlike traditional AI models that rely on predefined rules or templates, generative AI models have the ability to generate novel and creative outputs that mimic human-like behavior. In some aspects, the generative AI component 160 may be built using deep learning techniques, such as recurrent neural networks (RNNs) or generative adversarial networks (GANs), which enable the generative AI component 160 to learn from large datasets and generate new content by leveraging the patterns and structures it has learned.

Generally, the term child safety machine learning model 170 refers to an algorithm or system that has been trained to detect and address potential risks or threats to the safety of children. A child safety machine learning model 170 may be designed to analyze various types of data, such as text (e.g., such as would be present in online messages), images, voice (e.g., words spoken/received via a microphone/headset while playing online) or online behavior, to identify content or activities that may be harmful or inappropriate for children. Without wishing to be limited by theory, the child safety machine learning model 170 can be utilized in different contexts, such as social media platforms, online gaming environments, or content filtering systems to help identify and filter out content that contains explicit or violent material, cyberbullying, or other forms of online behavior or interactions that may pose risks to children.

In some aspects, the child safety machine learning model 170 is trained using large datasets that include examples of both safe and unsafe content, which allows the child safety machine learning model 170 to learn to recognize patterns, features, and context that are indicative of potential risks to children. In certain aspects, by leveraging machine learning techniques like deep neural networks, decision trees, or support vector machines, the child safety machine learning model 170 can make predictions and classify content as safe or potentially harmful.

In the embodiment illustrated in FIG. 1, the system 100 further includes an electronic communication device 180, which may be, for example, a smart phone, tablet, laptop computer, desktop computer, etc.). The electronic communication device 180 includes a screen 182 that may display a graphical user interface 185, which in turn may display a video gaming monitoring application 190. In some embodiments, the video gaming monitoring application 190 is configured to provide one or more primary users (e.g., adults, parents, guardians, etc.) having an account set up within the video gaming monitoring application 190 with the ability to monitor the video game-related activities (e.g., online gaming) of one or more secondary users (e.g., children, etc.) associated with the account set up by one or more of the primary users.

In some embodiments, the video gaming monitoring application 190 can be a dedicated application (e.g., an application specific to the electronic communication device 180) or a general application that that can provide or support video game play monitoring functions. In some embodiments, the video gaming monitoring application 190 can be a browser-based application that is native to an operating system of a remote computer or server or downloaded to and installed on the electronic communication device 180. In some embodiments, the video gaming monitoring application 190 can provide a link to a browser application on a remote computer or server to cause the browser application to display the user interface 185 on the electronic communication device 180.

In some embodiments, a primary user is permitted to download the video gaming monitoring application 190 and set up an account for use in monitoring and/or managing online video game play of one or more secondary users. In one aspect, when a primary user initially sets up a “family” account via the video gaming device 110 and/or the video gaming server 140 for monitoring and/or managing online video game play of one or more users associated with this account, the video gaming monitoring application 190 is configured to permit the primary user to generate an account profile, which may include a listing including all primary and secondary users associated with the account, personal information (e.g., name, address, age, etc.) of all users associated with the account, various options for setting up various permissions/restrictions for the secondary users, payment methods (e.g., credit card info), and/or options for monitoring and managing the online video game play of the secondary users and associated notifications.

In some aspects, as the user of the electronic communication device 180 (e.g., the primary user) attempts to connect over the network 130 to the video gaming server 140, the video gaming server 140 may request a verification of the identity (e.g., username/password) of the user (this username/password combination would have set up when setting up the account). The video gaming server 140 may verify the identity of the user of the electronic communication device 180 (e.g., by comparing the username/password data entered by the user of the electronic communication device 180 into the login interface against username/password data stored (e.g., in the memory of the video gaming server 140) in association with the profile of the primary user). If the entered username/password match the stored username/password, the video gaming server 110 may then retrieve the information stored in the profile of the primary user and enable the user to log in to the video gaming server 140.

Notably, in some aspects, the profile of the primary user may include electronic data representative of the access level of each user associated with the “family” account created by the primary user. For example, the access level may be such that the primary user and another person associated with the account and designated by the primary user have privileges to set up various permissions, restrictions, and monitoring/managing options with respect to the secondary users associated with the account. On the other hand, the access level may also restrict the ability of the secondary users associated with the account to view and/or modify the permissions, restrictions and/or monitoring/managing options set up by the primary user of the account.

In certain implementations, as will be discussed in more detail below, the video gaming monitoring application 190 is configured to generate a notification 128 for a primary user (e.g., parent, guardian, etc.) of the electronic communication device 180 of an online risk encountered by a secondary user (e.g., a child) playing the video gaming device 110 and linked by a common account (e.g., a “family” account) to the primary user of the electronic communication device 180. In one aspect, as discussed below, the notification 128 displayed by the video gaming monitoring application 190 within the user interface 185 and on a display 182 of the electronic communication device 180 presents the primary user of the electronic communication device 180 with one or more options (displayed by the video gaming monitoring application 190) for responding to the online risk encountered by the secondary user of the video gaming device 110 while playing a video game online with other players.

With reference to FIG. 2, an exemplary video gaming server 140 configured for use with exemplary systems and devices described herein includes a control circuit 310 including a programmable processor (e.g., a microprocessor or a microcontroller) electrically coupled via a connection 315 to a memory 320 and via a connection 325 to a power supply 330. The control circuit 310 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 310 can be configured (for example, by using corresponding programming stored in the memory 320 as will be well understood by those skilled in the art) to carry out one or more of the steps, actions, and/or functions described herein. In some embodiments, the memory 320 may be integral to the processor-based control circuit 310 or can be physically discrete (in whole or in part) from the control circuit 310 and is configured non-transitorily store the computer instructions that, when executed by the control circuit 310, cause the control circuit 310 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

In the embodiment illustrated in FIG. 2, the control circuit 310 of the video gaming server 140 is also electrically coupled via a connection 335 to an input/output 340 that can receive signals from and/or send signals to, for example, the video gaming device 110, risk module 150, electronic communication device 180, etc.

The processor-based control circuit 310 of the video gaming server 140 shown in FIG. 2 is electrically coupled via a connection 345 to a user interface 350, which may include inputs 370 (e.g., keyboard, mouse, touch screen, etc.) that permit an operator of the video gaming server 140 to manually control the video gaming server 140 by inputting commands via touch button operation and/or voice commands and/or via a physically connected device. In some embodiments, the user interface 350 of the video gaming server 140 may also include a speaker 360 that provides audible feedback (e.g., notifications, alerts, etc.) to the operator of the video gaming server 140. It will be appreciated that the performance of such functions by the processor-based control circuit 310 of the video gaming server 140 is not dependent on a human operator, and that the control circuit 310 of the video gaming server 140 may be programmed to perform such functions without a human operator.

As pointed out above, the risk module 150 and the video gaming server 140 may be implemented as separate, stand-alone devices as shown in FIG. 1. FIG. 2 shows an alternative embodiment where the video gaming server 140 incorporates the risk module 150. In the embodiment illustrated in FIG. 2, the risk module 150 is coupled to the processor-based control circuit 310 of the video gaming server 140 via a connection 355. Like the risk module 150 of FIG. 1, the risk module 150 of FIG. 2 includes or is coupled to a generative AI component 160 and a child safety machine learning model 170.

As pointed out above, the generative AI component 160 and the child safety machine learning model 170, in combination, are trained to detect and address potential risks or threats to the safety of secondary users (e.g., children) associated with a given account set up by a primary user. For example, the child safety machine learning model 170 may be designed to analyze text-based and voice-based messages received or sent by a secondary user while using the video gaming device 110 to play online, and to detect content or activities that may be harmful or inappropriate for the secondary user (e.g., by being explicit, violent, threatening, etc.). In one aspect, to maximize the effectiveness of the risk module 150, the generative AI component 160 and the child safety machine learning model 170 are specifically tailored for each of the individual “family” accounts set up by primary users of the video gaming monitoring application 190 by virtue of being trained only on data generated by the online interactions of the secondary users associated with each individual “family” account.

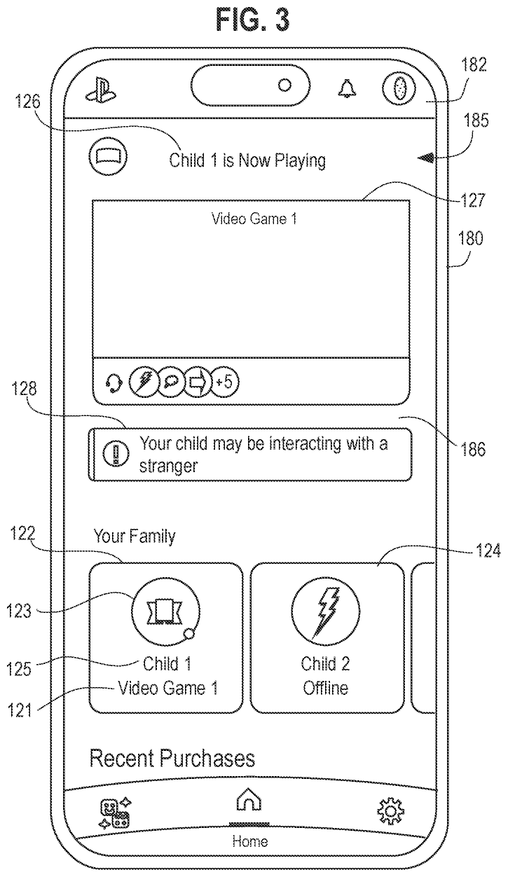

FIG. 3 illustrates an exemplary electronic communication device 180 (in this case, a mobile phone) with an exemplary user interface 185 and main menu 186 of the user interface 185 generated by a video gaming monitoring application 190 executable by the electronic communication device 180 being displayed on a screen 182 of the electronic communication device 180. As mentioned above, the video gaming monitoring application 190 permits the primary user of the electronic communication device 180 to monitor and/or manage the activity and online interactions of a secondary user linked to an account of the primary user while the secondary user plays video games on the video gaming device 110.

In the embodiment shown in FIG. 3, the graphical user interface 185 includes multiple interactive graphical icons 122 and 124, each of which displays a status 121, an avatar 123, and a name 125 of each secondary user (e.g., a child of the primary user) associated with a “family” account set up by the primary user. In this example, generic names Child 1 and Child 2 are used within the graphical icons 122 and 124, and a generic name “Video Game 1” for the video game title Child 1 is currently playing while Child 2 is Offline. It will be appreciated that the information displayed within the graphical icons 122, 124 is shown by way of example only, and the icons 122, 124 may include additional or alternative information in other embodiments.

The exemplary graphical user interface 185 depicted in FIG. 3 further includes informational fields 126, 127 and 128. In the illustrated example, informational field 126 shows the name of the secondary user (in this case, Child 1) and indicates the status of the secondary user (in this case, Child 1 is currently playing a video game). The interactive informational field 127 of the main menu 186 of the graphical user interface 185 shows the name of (and, optionally, a picture/photo/graphic associated with) the video game (in this case, “Video Game 1”) being played by Child 1, and avatars of online players who are playing Video Game 1 together with Child 1. In this example, three avatars are visible within the informational field 127 and a “+5” icon indicates that five additional players are also playing. Informational field 128 shows a notification of online risks being encountered by Child 1 (in this case, the notification is “Your child may be interacting with a stranger”). It will be appreciated that the informational fields 126, 127, and 128 displayed within the graphical user interface 185 are shown by way of example only, and that the user interface 185 may include additional or alternative informational fields in other embodiments.

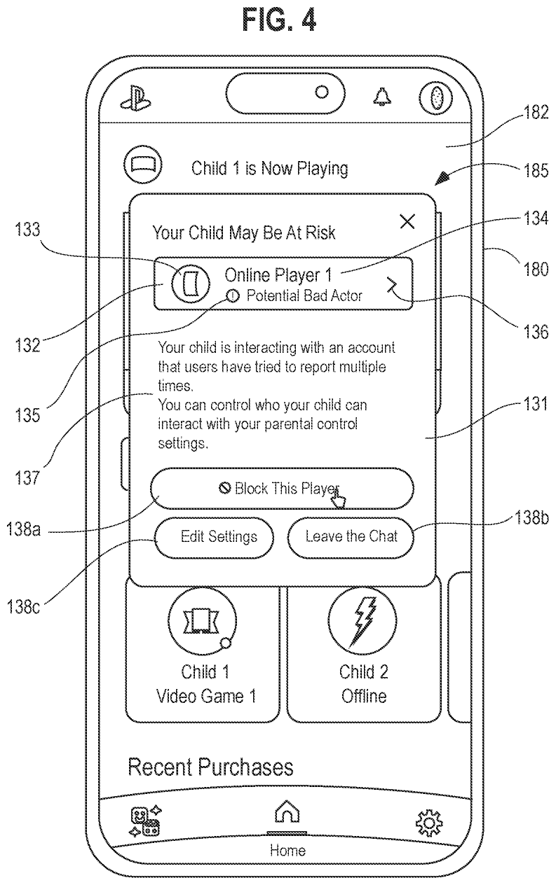

In the embodiment illustrated in FIG. 3, the information fields 127 and 128 of the user interface 185 are interactive and permit the primary user to tap/click on them to bring up sub-menus associated with the information fields 127 and 128. For example, if the primary user were to interact with the informational field 128 displaying the notification that Child 1 may have encountered a stranger (i.e., a player that is not in the friends list of Child 1), the graphical user interface 185 is configured to generate an exemplary interactive menu 131 visible in FIG. 4. In the embodiment illustrated in FIG. 4, the interactive menu 131 is displayed within the graphical user interface 185 as an overlay that overlays a portion of the main menu 186 of the graphical user interface 185 (shown in FIG. 3) such that portions of the main menu 186 remain visible.

The exemplary menu 131 of the graphical user interface 185 shown in FIG. 4 includes an interactive informational field 132, which, in this example, identifies the avatar 133 and screen name 134 (the generic screen name “Online Player 1” is used in this example) of the potential threat, and provides a text-based explanation 135 of the potential risk (in this case, pointing out that the user “Online Player 1” is a “Potential Bad Actor”). In the illustrated embodiment, to expand the informational field 132 and obtain more information regarding the gamer Online Player 1, the primary user of the gaming monitoring application 190 may interact with (e.g., tap, click, etc.) any portion of the information field 132, or may interact with (e.g., tap, click, etc.) an interactive graphical icon 136 to expand the informational field 132.

With reference to FIG. 4, the exemplary informational field 132 further includes an informational field 137, which may provide a text-based explanation of the detected potential online risk, i.e., “Your child is interacting with an account that users have tried to report multiple times,” and indicate what the primary user can do to address this potential online risk, i.e., “You can control who your child can interact with in your parental control settings.” In the illustrated embodiment, the interactive menu 131, in addition to informing the primary user of the potential online risks to the secondary user, presents the primary user with one or more options for responding to the online risk by providing three separate interactive icons/buttons that the primary user may interact with.

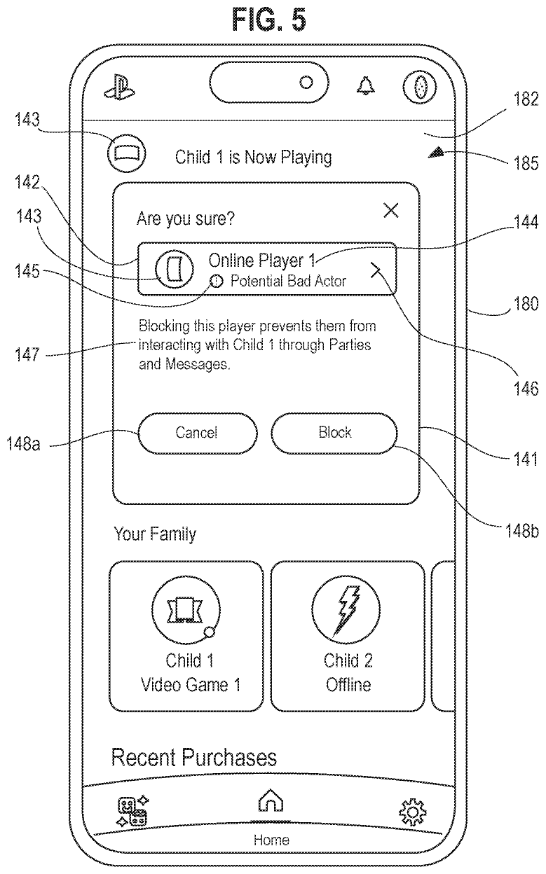

For example, the exemplary menu 131 shown in FIG. 4 includes an interactive icon 138a that permits the primary user to block the potential bad actor Online Player 1. In other words, to block the gamer Online Player 1 from interacting (e.g., messaging, chatting, etc.) with Child 1 when Child 1 plays online, the primary user would interact with (e.g., press or click) icon/button 138a (which, in this example, is labeled “Block This Player”). In the illustrated embodiment, when the primary user interacts with the icon 138a (i.e., “Block This Player”), the graphical user interface 185 is configured to generate an exemplary interactive menu 141 visible in FIG. 5. In the embodiment of FIG. 5, the interactive menu 141 is displayed within the graphical user interface 185 as an overlay over a portion of the main menu 186 of the graphical user interface 185 (shown in FIG. 3) such that portions of the main menu 186 remain visible.

In the embodiment illustrated in FIG. 4, the exemplary menu 131 shown in FIG. 4 includes an interactive icon 138b (in this example, named “Leave the Chat”), which permits the primary user to leave/close the informational field 132 without taking any action with respect to the gamer Online Player 1. In some embodiments, the interactive icon 138 named “Leave the Chat” may permit the primary user to force Child 1 to leave the current interaction with the potential bad actor (i.e., disconnect Child 1 from the current interaction). The exemplary menu 131 of FIG. 4 further includes an interactive icon/button 138c (in this example, called “Edit Settings,” which permits the primary user to edit the settings with respect to monitoring and/or management of online risk detection with respect to secondary user (i.e., Child 1).

Similar to the exemplary menu 131 of FIG. 4, the exemplary menu 141 of the graphical user interface 185 shown in FIG. 5 includes an interactive informational field 142, which, identifies the avatar 143 and screen name 144 of the online gamer that presents potential risk and provides a text-based explanation 145 of the potential threat (in this case, pointing out that the gamer “Online Player 1” is a “Potential Bad Actor”). The informational field 142 of menu 141 may be expanded to obtain more information regarding the gamer Online Player 1 by interacting with any portion of the information field 142, or by interacting with an interactive graphical icon 146 to expand the informational field 142.

The exemplary menu 141 shown in FIG. 4 further includes an interactive icon/button 148a, which permits the primary user to leave/close the menu 141 without blocking the gamer Online Player 1. In the illustrated embodiment, the interactive icon/button 148a displayed within the menu 141 is called “Cancel.”

The exemplary menu 141 shown in FIG. 5 also includes an interactive icon/button 148b, which permits the primary user to block the gamer Online Player 1 from interacting with Child 1 when Child 1 plays online. In the illustrated embodiment, the interactive icon/button 148b displayed within the menu 141 is called “Block.” The menu 141 shown in FIG. 5 further includes an informational field 147, which, in this example, provides a text-based explanation of the effect of the “Block” action that may be taken by the primary user by interacting with the icon 148b. In this example, the informational field 147 indicates that “Blocking this player prevents them from interacting with Child 1 through Parties and Messages.”

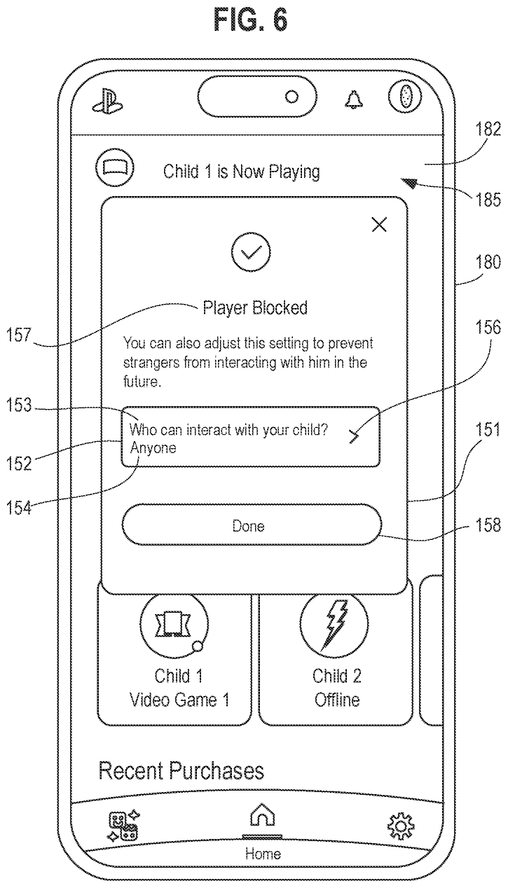

In one aspect, when the primary user interacts with the icon 148b (i.e., “Block”), the graphical user interface 185 is configured to generate an exemplary interactive menu 151 visible in FIG. 6. In the embodiment illustrated in FIG. 6, the interactive menu 151 is displayed within the graphical user interface 185 as an overlay that overlays a portion of the main menu 186 of the graphical user interface 185 (shown in FIG. 3) such that portions of the main menu 186 remain visible.

The exemplary menu 151 of the graphical user interface 185 shown in FIG. 6 includes an informational field 157, which, in this example, provides a text-based explanation of the action that has been taken by the video gaming monitoring application 190 in response to the primary user pressing icon 148b within the menu 141 of FIG. 5. In this example, the informational field 157 indicates that the action taken in this case is “Player Blocked.” In the illustrated embodiment, the informational field 157 may also indicate further actions that the primary user can take within the video gaming monitoring application 190. In this example, the informational field 157 provides a text-based message indicating that “You can also adjust this setting to prevent strangers from interacting with Child 1 in the future.”

To that end, the menu 151 includes an interactive informational field 152, which includes a text field 153 indicating that the setting that can be adjusted by interaction with the informational field 152 (in this example, “Who can interact with your child?”), as well as a text field 154 indicating the current setting that is currently set for the child (in this example, “Anyone”). In the illustrated embodiment, to expand the informational field 152 and obtain more information regarding the settings that may be applied by the primary user with respect to who the secondary user (e.g., Child 1) can interact while playing video games online, the primary user may interact with (e.g., tap, click, etc.) any portion of the information field 152, or may interact with (e.g., tap, click, etc.) an interactive graphical icon 156 to expand the informational field 152.

The exemplary menu 151 of FIG. 6 further includes an interactive icon/button 158, which permits the primary user to close the menu 151 and return to the main menu 186 of the user interface 185, which is illustrated in FIG. 3. In the illustrated embodiment interactive icon/button 158 displayed within the menu 151 is called “Done.”

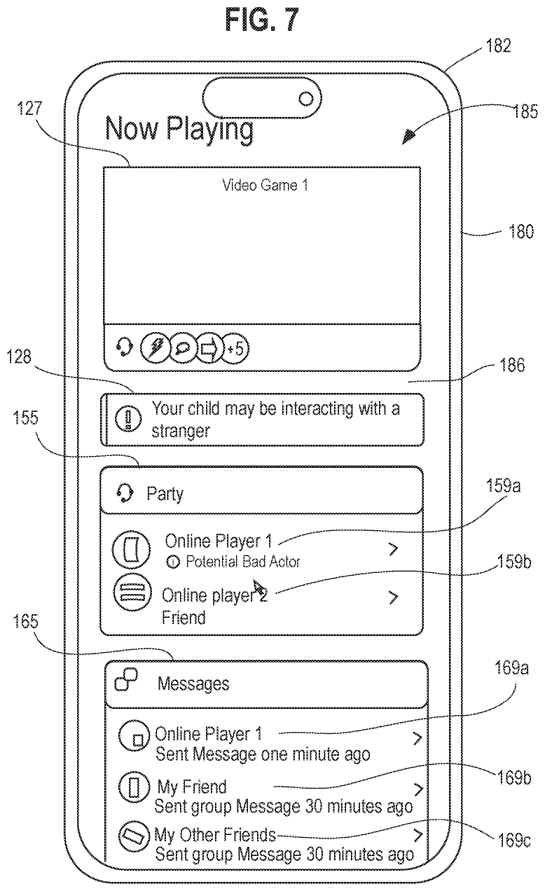

FIG. 7 illustrates the exemplary user interface 185 generated by a video gaming monitoring application 190 in response to the primary user of the electronic communication device 180 interacting with the interactive informational field 127 showing the name of (i.e., Video Game 1) and/or a graphic associated with the video game being played by the secondary user (i.e., Child 1). FIG. 7 shows that, the interactive informational field 127, when interacted with (e.g., clicked, tapped, etc.) by the primary user, provides the primary user of the electronic communication device 180 with further information regarding the online interactions of Child 1 with other gamers while Child 1 plays Video Game 1.

In particular, the exemplary user interface 185 shown in FIG. 7 includes an informational field 165 (in this example, named “Messages”), which shows both the names of the online gamers who sent messages to Child 1 and when each of the messages was sent to Child 1. In the example shown in FIG. 7, the informational field 165 entitled Messages includes: an informational field 169a indicating that Online Player 1 sent a message to Child 1 one minute ago; an informational field 169b indicating that a gamer in the Friends list of Child 1 sent a message to a group including Child 1 thirty minutes ago; and an informational field 169c indicating that another gamer (i.e., “My Other Friends”) in the Friends list of Child 1 sent a message to Child 1 one minute ago. In some embodiments, each of the informational fields 169a-169c is interactive and, when interacted with by the primary user, displays the content of the online message associated with the one of the informational fields 169a-169c the primary user interacted with.

The exemplary user interface 185 shown in FIG. 7 further includes an informational field 155 (in this example, named “Party”), which shows the list of online gamers Child 1 is currently playing Video Game 1 with (and with whom Child 1 may be messaging and/or chatting while playing Video Game 1). In the example shown in FIG. 7, the main menu 186 of the graphical user interface includes interactive informational fields 159a and 159b, indicating that Child 1 is playing Video Game 1 with gamers Online Player 1 (visibly identified in informational field 159a as a “Potential Bad Actor” with respect to Child 1) and Online Player 2 (identified in informational field 159b as a “Friend” with respect to Child 1), respectively.

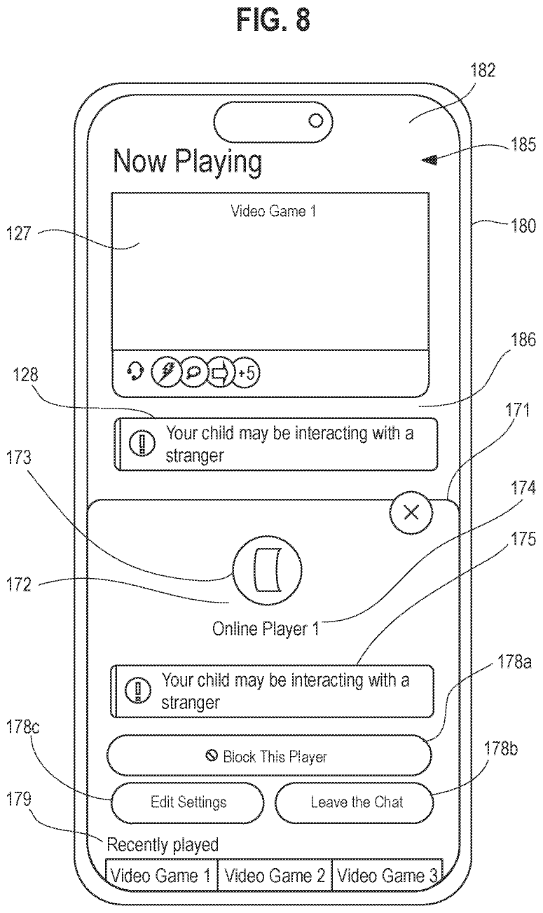

In the example shown in FIG. 7, if the primary user were to interact with the interactive informational field 159a displaying the notification that user Online Player 1 is a Potential Bad Actor, the graphical user interface 185 is configured to generate an exemplary interactive menu 171, which is visible in FIG. 8 and akin to the menu 131 depicted in FIG. 4. In the embodiment illustrated in FIG. 8, the interactive menu 171 is displayed within the graphical user interface 185 as an overlay that overlays a portion of the main menu 186 of the graphical user interface 185 (shown in FIG. 3) such that portions of the main menu 186 remain visible.

In the embodiment illustrated in FIG. 8, the interactive menu 171 includes an informational field 172, which, in this example, identifies the avatar 173 and screen name 174 (in this example, Online Player 1) of the online gamer presenting a potential risk to Child 1. In addition, the exemplary menu 171 displays a notification 175 of the online risk being encountered by Child 1 (in this case, the notification is “Your child may be interacting with a stranger”), as well as several interactive icons/buttons 178a-178c, which permit the primary user to respond to the notification 175 of an online risk to Child 1 displayed within the menu 171.

For example, interactive icon 178a permits the primary user to block the potential bad actor Online Player 1. In other words, to block Online Player 1 from interacting with Child 1 when the Child 1 plays online, the primary user would interact with (e.g., press or click) the icon/button 178a (which, in this example, is labeled “Block This Player”).

Interactive icon 178b of the exemplary menu 171 (in this example, named “Leave the Chat”) permits the primary user to leave/close the menu 171 without taking any action with respect to Online Player 1. The exemplary menu 171 of FIG. 8 further includes an interactive icon/button 178c (in this example, called “Edit Settings,” which permits the primary user to edit the settings with respect to monitoring and/or managing online risks encountered by the secondary user (i.e., Child 1). In the illustrated embodiment, the interactive menu 171 further includes an informational field 179 (in this example, called “Recently Played”) that indicates the video games recently played by Child 1 (in this example, Video Game 1, Video Game 2, and Video Game 3).

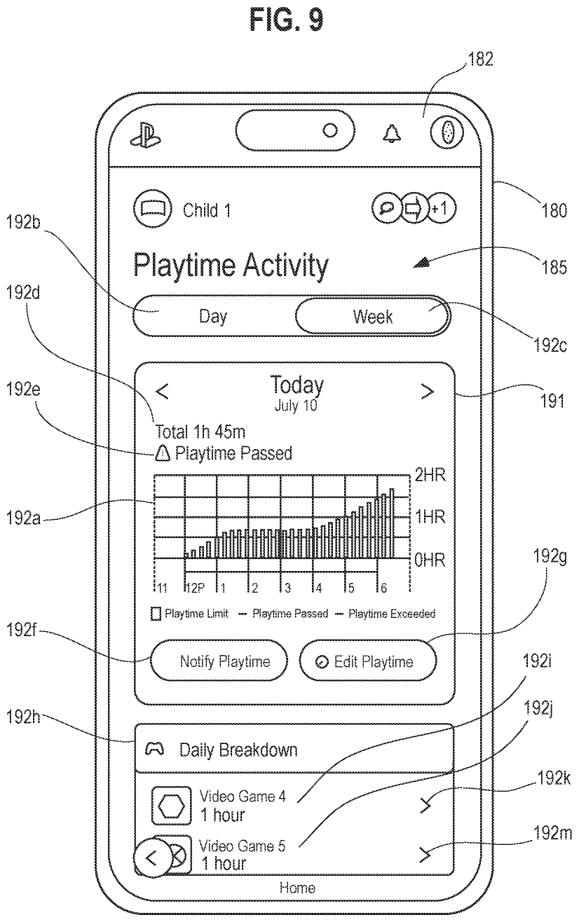

FIGS. 3-8 discussed above describe various features and functions of the video gaming monitoring application 190 in the context of monitoring/managing online risks that a secondary user (e.g., Child 1, Child 2, etc.) associated with an account of the primary user (e.g., parent, guardian, etc.) of the electronic communication device 180. FIGS. 9-11, on the other hand, relate to exemplary activity reports that may be generated by the video gaming monitoring application 190 with respect to any of the secondary users, and presented to the primary user within the graphical user interface 185 on the screen 182 of the electronic communication device 180.

For example, FIG. 9 shows the graphical user interface 185 displaying an exemplary informational field 191 including a gaming activity report 192a (in bar graph form, but any other form other than bar graph may be used) for the secondary user (in this example, Child 1) within a time interval selected by the primary user. In particular, the informational field 191 includes an interactive visual indicator 192b (called “Day”) that allows the primary user to select one day as the chosen time interval, and an interactive visual indicator 192c (called “Week”) that allows the primary user to select one week as the chosen time interval. It will be appreciated that, in some embodiments, the graphical user interface 185 may also include an interactive visual indicator that would permit the primary user to select one month or one year as the chosen time interval. In the example shown in FIG. 9, the primary user has selected one day as the desired time interval and the day chosen by the primary user in this example is “Today, July 10.”

In the embodiment illustrated in FIG. 9, the informational field 191 includes a visual indicator 192d of the total time (in this example, 1 hour, 45 minutes) Child 1 played video games on the day (i.e., July 10) selected by the primary user. The informational field 191 further includes a visual indicator 192e indicating whether Child 1 has exceeded the maximum video game playing time permitted (in the settings of the gaming monitoring application 190) for Child 1 by the primary user. In this case, the visual indicator 192 indicates that Child 1 has exceeded the maximum permissible daily video game playtime, which is reflected by the exclamation sign within a triangle and by a text-based message that says “Playtime Passed.”

In the illustrated embodiment, to provide the primary user with more control over the time Child 1 spends on video games, the informational field 191 includes an interactive icon/button 192f (in this example, called “Notify Playtime”), which, when interacted with by the primary user, causes the video gaming monitoring application 190 to generate a visible (e.g., on the screen 182 of the electronic communication device 180) and/or an audible (e.g., via a speaker of the electronic communication device 180) notification that the maximum video game playtime permitted for Child 1 has been reached by Child 1. This, of course, would advantageously enable the primary user to inform Child 1 that Child 1 has to stop playing video games before Child 1 overplays the permitted playtime by 1 hour and 45 minutes, as in the example shown in FIG. 9.

The informational field 191 of the exemplary graphical user interface 185 of FIG. 9 further includes an interactive icon/button 192g (in this example, called “Edit Playtime”), which, when interacted with by the primary user, causes the video gaming monitoring application 190 to generate, within the graphical user interface 185, a menu that enables the primary user to decrease or increase the total time per day or per week that Child 1 is permitted to play video games on the video gaming device 110, or to set specific time intervals (e.g., from 6pm to 7pm) when the Child 1 is permitted to play video games on a given day.

In the embodiment illustrated in FIG. 9, the informational field 191 of the graphical user interface 185 of FIG. 9 further includes an informational field 192h (in this example, called “Daily Breakdown”), which includes a listing indicating the title of each video game played by Child 1 on the day selected by the primary user, as well as the total time Child 1 played each video game on the day selected by the primary user. For example, in the example shown in FIG. 9, the informational field 192h shows two listings 192i and 192j, with listing 192i indicating that Child 1 played one game, i.e., Video Game 4 for 1 hour in one gaming session, and listing 192j indicating that Child 1 played another game, i.e., Video game 5 for 1 hour in another gaming session.

In the illustrated embodiment, each listing 192i and 192j is an interactive field, which, when interacted with (e.g., tapped, clicked, etc.) by the primary user, enables the primary user to see more detailed information with respect to either of the two gaming sessions listed under the informational field 192h. For example, to expand the listing 192i and obtain more information regarding the latest gaming session engaged in by Child 1, the primary user may interact with (e.g., tap, click, etc.) any portion of interactive field 192i or 192j, or may interact with (e.g., tap, click, etc.) a graphical icon 192k or 192m associated with interactive fields 192i and 192j, respectively.

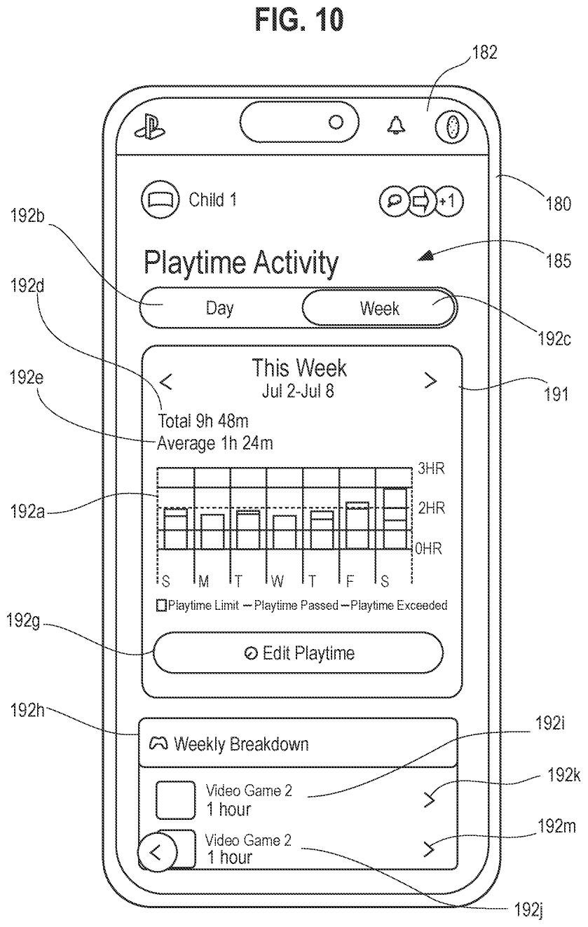

FIG. 10 is similar to FIG. 9. However, while FIG. 9 shows the graphical user interface 185 after the primary user interacted with the interactive icon 192b (i.e., Day), FIG. 10 shows the graphical user interface 185 after the primary user interacted with the interactive icon 192c (i.e., Week), with the week being chosen by the primary user in this being “July 2-July 8.” As such, the exemplary graphical gaming activity report 192a (in chart form) indicates how many hours per each day of the week of July 2-July 8 Child 1 spent playing video games. In addition, in the illustrated example, gaming activity report 192a may indicate the playtime that does not exceed the maximum permitted daily playtime in one color (e.g., green) and the playtime that exceeds the maximum permitted daily playtime in another color (e.g., red).

In the embodiment illustrated in FIG. 10, the informational field 191 includes a visual indicator 192d of the total time (in this example, 9 hours 48 minutes) Child 1 played video games during the week selected by the primary user. The exemplary visual indicator 192e of informational field 191 of FIG. 10 indicates the daily average time (in this example, 1 hour 24 minutes) spent by Child 1 playing video games.

Similarly to FIG. 9, the graphical user interface 185 displayed in FIG. 10 includes an interactive icon/button 192g (in this example, called “Edit Playtime”), which, when interacted with by the primary user, causes the video gaming monitoring application 190 to generate, within the graphical user interface 185, a menu that enables the primary user to decrease or increase the total time per day or per week that Child 1 is permitted to play video games on the video gaming device 110, or to set specific time intervals (e.g., from 6pm to 7pm) when Child 1 is permitted to play video games on a given day. In the embodiment illustrated in FIG. 10, the informational field 191 of the graphical user interface 185 also includes an informational field 192h (i.e. “Weekly Breakdown), which was discussed in detail with reference to FIG. 9.

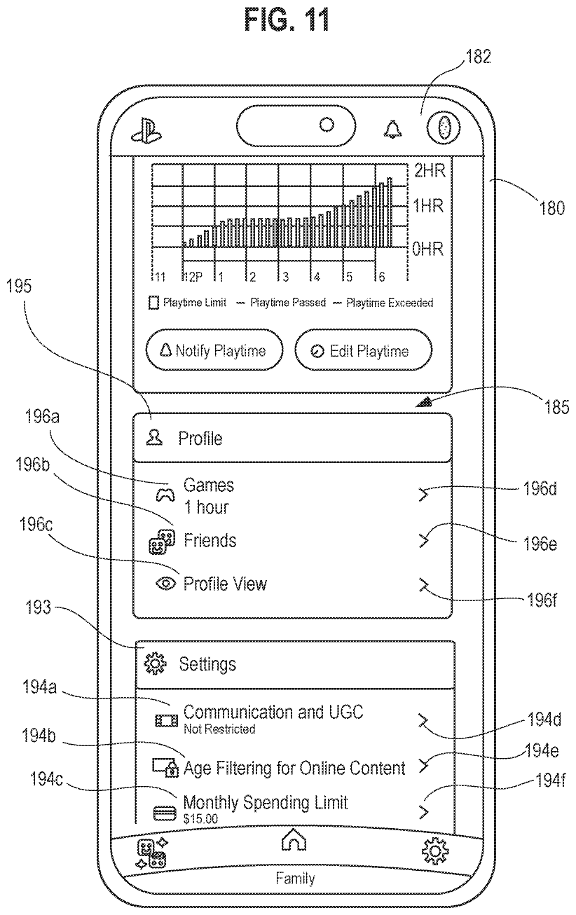

FIG. 11 illustrates an exemplary graphical user interface 185 that includes an informational field 193 displaying various monitoring/management settings options that may be viewed and/or adjusted by the primary user. The exemplary informational field 193 associated with the settings-related options (and called “Settings” in this example) includes a listing of various settings/restrictions that the primary user can set with respect to Child 1. In the example shown in FIG. 11, the informational field 193 called “Settings” has three underlying listings 194a-194c.

In particular, listing 194a is an interactive field, which, when interacted with (e.g., clicked, tapped, etc.) by the primary user, permits the primary user to view various “Communication and UGC” options with respect to Child 1. Notably, the exemplary interactive field 194a indicates the status of the Communication and UGC setting (i.e., “Not Restricted”). In the illustrated embodiment, to cause the graphical user interface 185 to expand the listing 194a and view and/or adjust the Communication and UGC settings for Child 1, the primary user may interact with any portion of the interactive field 194a, or with the graphical icon 194e associated with interactive field 194d. This would allow the primary user to, for example, change the “Not Restricted” setting of Communication and UGC to a more restricted setting based on one or more parameters specified by the primary user.

Generally speaking, in the context of video game content, “Communication” may refer to the interaction and exchange of information between online players within a video game or through external channels. This can include in-game chat, voice chat, messaging systems, and social features that enable players to connect and collaborate. As used herein, “UGC” stands for User-Generated Content, which refers to content created by players themselves rather than the game developers. UGC may include custom levels, mods, character skins, game modes, and other player-created assets that enhance or modify the game experience.

The exemplary listing 194b is an interactive field, which, when interacted with (e.g., clicked, tapped, etc.) by the primary user, permits the primary user to view various “Age Filtering for Online Content” options with respect to Child 1. In the illustrated embodiment, to cause the graphical user interface 185 to expand the listing 194b and view the Age Filtering for Online Content settings for Child 1, the primary user may interact with any portion of the interactive field 194b, or with the graphical icon 194e associated with interactive field 194b. This would allow the primary user to, for example, change the settings for the type of content (e.g., “Restrict/Don't Restrict,” or “G-rated,” “PG-rated,” “R-rated,” etc.) that Child 1 may access and/or be exposed to when playing online.

Listing 194c is an interactive field, which, when interacted with (e.g., clicked, tapped, etc.) by the primary user, permits the primary user to view various “Monthly Spending Limit” options with respect to Child 1. In the example illustrated in FIG. 11, the primary user preset a monthly limit of $15 as the maximum amount Child 1 can spend per month on video games, in-game purchases, etc. In the illustrated embodiment, to cause the graphical user interface 185 to expand the listing 194c and view and/or modify (e.g., increase or decrease) the Monthly Spending Limit for Child 1, the primary user may interact with any portion of the interactive field 194c, or with the graphical icon 194f associated with interactive field 194c.

The exemplary graphical user interface 185 shown in FIG. 11 further includes various profile-related options that may be viewed and/or adjusted by the primary user. In FIG. 11, the exemplary informational field 195 associated with various profile-related options (and called “Profile” in this example) includes a listing of various options/restrictions that the primary user can set with respect to Child 1. In the example shown in FIG. 11, the informational field 195 called “Profile” has three underlying listings 196a-196c.

In particular, listing 196a is an interactive field (in this example, called “Games”), which, when interacted with (e.g., clicked, tapped, etc.) by the primary user, permits the primary user to view the video games played by Child 1 within a primary user-selected time interval and to view the total time spent by Child 1 playing each video game. For example, to cause the graphical user interface 185 to expand the listing 196a and view each video game played by Child 1 on a given day and the total time spent by Child 1 playing each video game, the primary user may interact with any portion of interactive field 196a, or with a graphical icon 196d associated with interactive field 196a.

Listing 196b is an interactive field, which, when interacted with (e.g., clicked, tapped, etc.) by the primary user, permits the primary user to view the “Friends” list of Child 1. For example, if the primary user were to expand the listing 196b by tapping on the interactive field 196b or on the graphical icon 196e associated with the interactive field 196b, the graphical user interface 185 would generate a list of online gamers that Child 1 added as a friend.

Listing 196c is an interactive field, which, when interacted with (e.g., clicked, tapped, etc.) by the primary user, permits the primary user to view, set, and/or adjust various profile-related options specific to the online video game play by Child 1. For example, to cause the graphical user interface 185 to expand the listing 196c and view/set/adjust various options associated with the profile of Child 1, the primary user may interact with any portion of interactive field 196c, or with a graphical icon 196f associated with interactive field 196c.

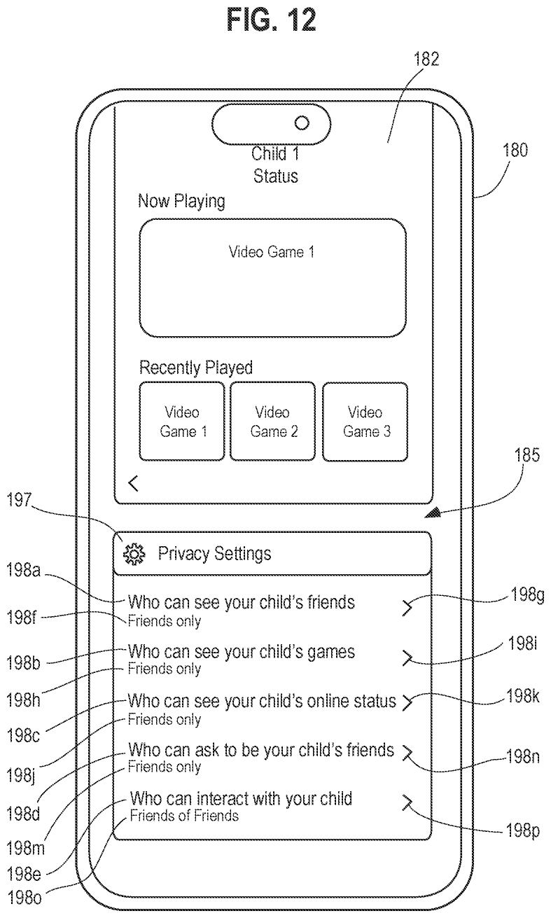

FIG. 12 illustrates the exemplary user interface 185 generated by a video gaming monitoring application 190 in response to the primary user of the electronic communication device 180 interacting with the interactive informational field 196c called “Profile View.” In the example shown in FIG. 12, the exemplary graphical user interface 185 displays an informational field 197 associated with various profile-related options (and called “Privacy Settings” in this example) that the primary user can set with respect to Child 1. In some embodiments, the Profile View enables the primary user to view what information in the profile of Child 1 friends of Child 1 will see when viewing the profile of Child 1 online.

In the example shown in FIG. 12, the informational field 197 has five underlying listings 198a-198e. In particular, the listing 198a in FIG. 12 is an interactive field, which, when interacted with (e.g., clicked, tapped, etc.) by the primary user, permits the primary user to view options relating to “Who can see your child's friends” with respect to Child 1. In some aspects, such options may include “Anyone,” “Friends Only,” “Friends of Friends,” “No One,” etc. Notably, the exemplary interactive field 198a includes a text-based indicator 198f indicating the current setting of the “Who can see your child's friends” setting. In the example illustrated in FIG. 12, the text-based indicator 198f displays “Friends Only,” which means that only video game players included in the Friends list of Child 1 are able to see the Friends list of Child 1. In the illustrated embodiment, to cause the graphical user interface 185 to expand the listing 198a and view the list of names/avatars of the players that are on the Friends list of Child 1 and are thus permitted to view the Friends list of Child 1, the primary user may interact with any portion of the interactive field 198a, or with the graphical icon 198g associated with the interactive field 198a.

The listing 198b in FIG. 12 is an interactive field, which, when interacted with (e.g., clicked, tapped, etc.) by the primary user, permits the primary user to view options relating to “Who can see your child's games” with respect to Child 1. In some aspects, such options may include “Anyone,” “Friends Only,” “Friends of Friends,” “No One,” etc. Notably, the exemplary interactive field 198b includes a text-based indicator 198h indicating the current setting of the “Who can see your child's games” setting. In the example illustrated in FIG. 12, the text-based indicator 198h displays “Friends Only,” which means that only gamers included in the Friends list of Child 1 are able to see the list of video games played by Child 1. In the illustrated embodiment, to cause the graphical user interface 185 to expand the listing 198b and view the list of video games played by Child 1, the primary user may interact with any portion of the interactive field 198b, or with the graphical icon 198i associated with the interactive field 198b.

The listing 198c in FIG. 12 is an interactive field, which, when interacted with (e.g., clicked, tapped, etc.) by the primary user, permits the primary user to view options relating to “Who can see your child's online status” with respect to Child 1. In some aspects, such options may include “Anyone,” “Friends Only,” “Friends of Friends,” “No One,” etc. Notably, the exemplary interactive field 198c includes a text-based indicator 198j indicating the current setting of the “Who can see your child's online status” setting. In the example illustrated in FIG. 12, the text-based indicator 198j displays “Friends Only,” which means that only video game players included in the Friends list of Child 1 are able to see the online status of Child 1 (i.e., whether Child 1 is online or offline). In the illustrated embodiment, to cause the graphical user interface 185 to expand the listing 198c and view the online status of Child 1, the primary user may interact with any portion of the interactive field 198c, or with the graphical icon 198k associated with the interactive field 198c.

The listing 198d in FIG. 12 is an interactive field, which, when interacted with (e.g., clicked, tapped, etc.) by the primary user, permits the primary user to view options relating to “Who can ask to be your child's friend” with respect to Child 1. In some aspects, such options may include “Anyone,” “Friends Only,” “Friends of Friends,” “No One,” etc. Notably, the exemplary interactive field 198d includes a text-based indicator 198m indicating the current setting of the “Who can see ask to be your child's friend” setting. In the example illustrated in FIG. 12, the text-based indicator 198m displays “Friends Only,” which means that only video game players included in the Friends list of Child 1 are able to send a “Friend Request” to Child 1. In the illustrated embodiment, to cause the graphical user interface 185 to expand the listing 198d and view the list of names/avatars of the players that are friends of Child 1 and are thus permitted to send friend requests to Child 1, the primary user may interact with any portion of the interactive field 198d, or with the graphical icon 198n associated with the interactive field 198d.

The listing 198e in FIG. 12 is an interactive field, which, when interacted with (e.g., clicked, tapped, etc.) by the primary user, permits the primary user to view options relating to “Who can interact with your child” with respect to Child 1. In some aspects, such options may include “Anyone,” “Friends Only,” “Friends of Friends,” “No One,” etc. Notably, the exemplary interactive field 198e includes a text-based indicator 198o indicating the current setting of the “Who can interact with your child” setting. In the example illustrated in FIG. 12, the text-based indicator 198o displays “Friends of Friends,” which means that only video game players who are Friends of the players in the Friends list of Child 1 are able to interact with Child 1 online. In the illustrated embodiment, to cause the graphical user interface 185 to expand the listing 198e and view the list of names/avatars of the players that are Friends of Friends Child 1 and are thus permitted to interact with Child 1 online, the primary user may interact with any portion of the interactive field 198e, or with the graphical icon 198p associated with the interactive field 198e.

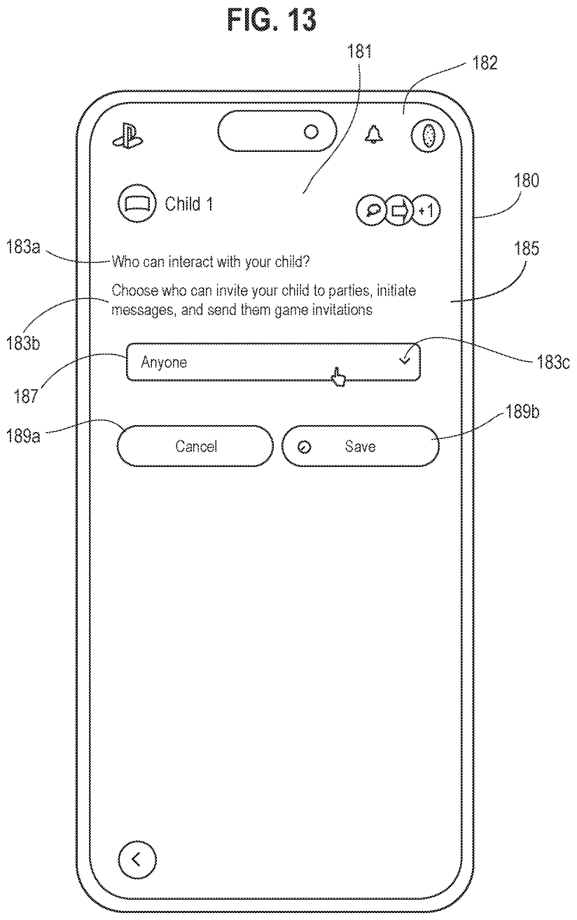

FIG. 13 illustrates the exemplary user interface 185 generated by a video gaming monitoring application 190 in response to the primary user of the electronic communication device 180 interacting with the interactive informational field 196e called “Who can interact with your child.” In the example shown in FIG. 13, the exemplary graphical user interface 185 displays an exemplary sub-menu 181 including a text-based indicator 183a depicting the name of this menu 181, in this example, “Who can interact with your child.” In addition, the exemplary sub-menu 181 includes a text-based indicator 183b indicating what kind of options are available to the primary user within the sub-menu 181. In the example illustrated in FIG. 13, the text-based indicator 183b informs the primary user that the menu 141 allows the primary user to “Choose who can invite your child to parties, initiate message, and send them game invitations.”

The exemplary menu 181 of FIG. 13 of the user interface 185 of the video gaming monitoring application 190 includes an exemplary drop-down menu 187, which, when interacted with (e.g., clicked, tapped, etc.) by the primary user, permits the primary user to view selectable options relating to which online video gamers can interact with Child 1 while Child 1 is playing a video game online. The drop-down menu 187 visible within the exemplary menu 181 of FIG. 13 shows the “Anyone” option as being selected, which means that any video game player who is online may interact with Child 1. Notably, in the embodiment illustrated in FIG. 13, the graphical icon 183c associated with the exemplary drop-down menu 187 is oriented with its peak pointed downwardly to indicate that the drop-down menu 187 is not in an expanded state.

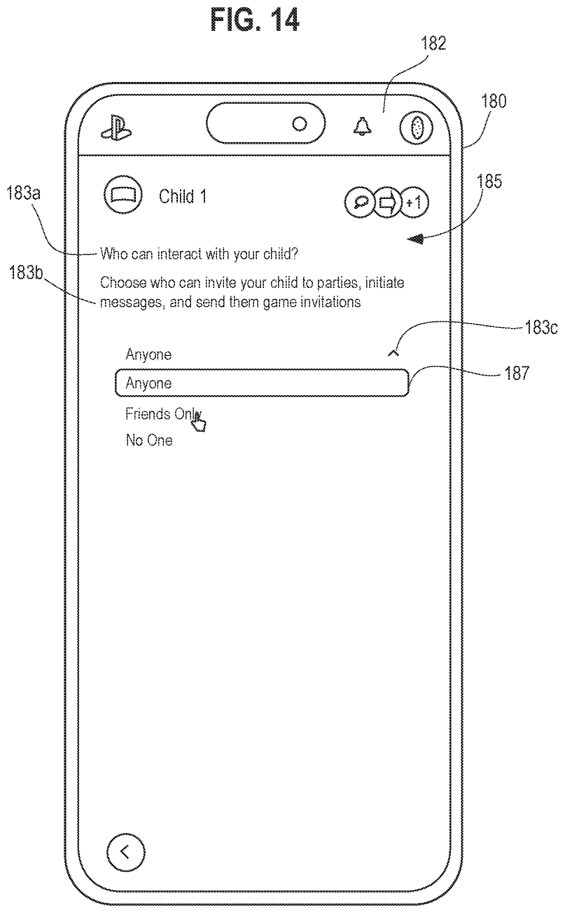

FIG. 14 illustrates the exemplary user interface 185 generated by the video gaming monitoring application 190 in response to the primary user of the electronic communication device 180 interacting with the drop-down menu 187 to expand the drop-down menu 187 and display all exemplary options available for selection by the primary user within the drop-down menu 187. In the example shown in FIG. 14, the options available for selection to the primary user include “Anyone” (which is currently actively selected), “Friends Only” (the selection of which by the primary user means that only video game players in the Friends list of Child 1 may interact with Child 1), and “No One” (the selection of which by the primary user means that none of the video game players who are online may interact with Child 1). Notably, in the embodiment illustrated in FIG. 14, the graphical icon 183c associated with the exemplary drop-down menu 187 is oriented with its peak pointed upwardly to indicate that the drop-down menu 187 is in an expanded state.

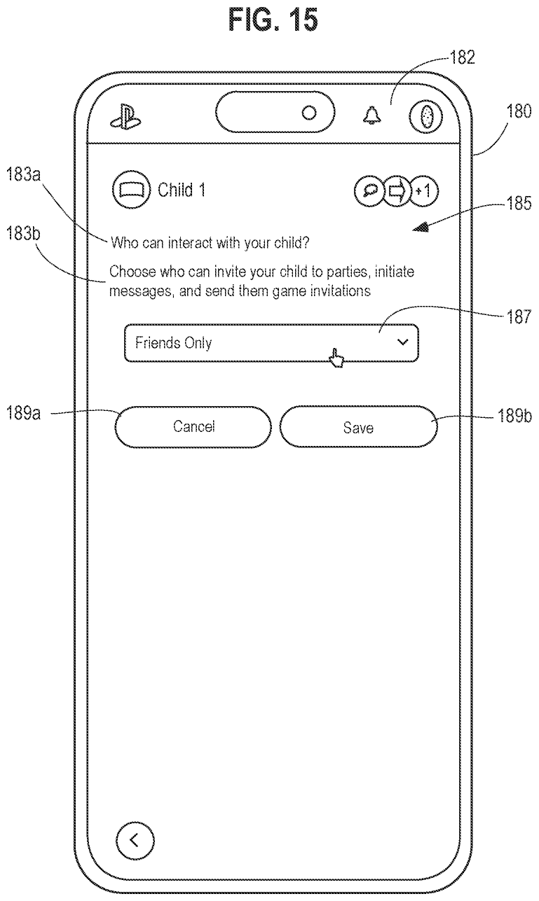

FIG. 15 illustrates the exemplary user interface 185 generated by the video gaming monitoring application 190 in response to the primary user of the electronic communication device 180 interacting with the “Friends Only” option of the drop-down menu 187 to restrict the amount of online players who can interact with Child 1 and to change the “Anyone” option (which allows any video game player who is online to interact with Child 1) to the “Friends Only” option (which allows only video game players in the Friends list of Child 1 to interact with Child 1).

In the embodiment illustrated in FIG. 15, the graphical user interface further includes interactive icons/buttons 189a and 189b. Icon/button 189a (called “Cancel” in this example) permits the primary user to cancel the substitution of the “Anyone” option with the “Friends Only” option and to return the drop-down menu 187 with the “Anyone” option still being selected as shown in FIG. 14. On the other hand, icon/button 189b (called “Save” in this example) permits the primary user to enact/implement the substitution of the “Anyone” option with the “Friends Only” option and to return the drop-down menu 187 with the “Friends Only” option being selected. With the “Friends Only” option being saved by virtue of the user having interacted with the button 189b, the gaming monitoring application 190 will no longer permit any video game player who is online to interact with Child 1, but will instead only permit the players on the Friends list of Child 1 to interact with Child 1 while Child 1 is online and playing a video game.

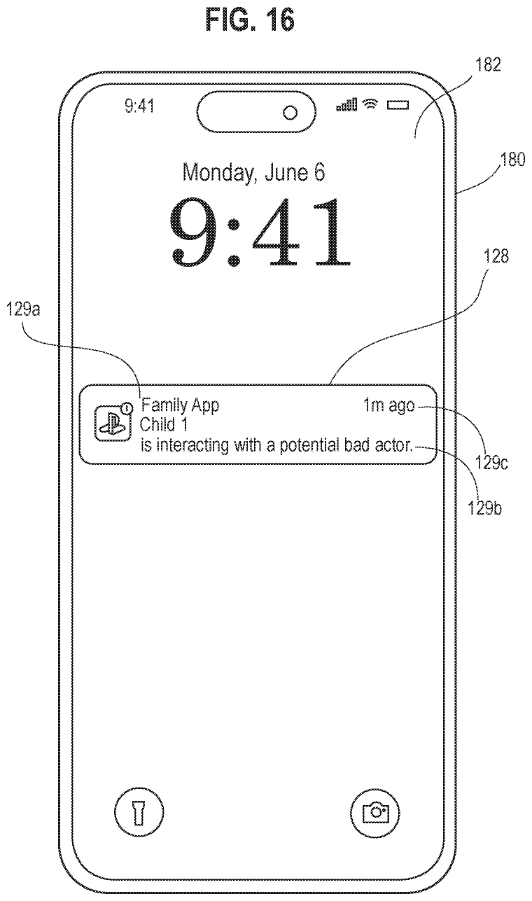

FIG. 16 shows an exemplary notification 128 of an online risk presented to Child 1 while Child 1 is playing video games online, but this notification 128 is not displayed within the graphical user interface 185 discussed above, and is instead displayed to the primary user within the main menu 186 of the graphical user interface 185 on the screen 182 of the electronic communication device 180. The exemplary notification 128 includes an informational field 129a that indicates the name of the secondary user that has encountered an online risk while playing a video game online (in this case, Child 1). In addition, the exemplary notification 128 includes an informational field 129b that indicates the type of online risk that Child 1 has encountered while playing a video game online (in this case, that Child 1 is “interacting with a potential bad actor). The exemplary notification 128 also includes an informational field 128c that indicates when Child 1 encountered a risk while playing a video game online (in this example, 1 minute ago).

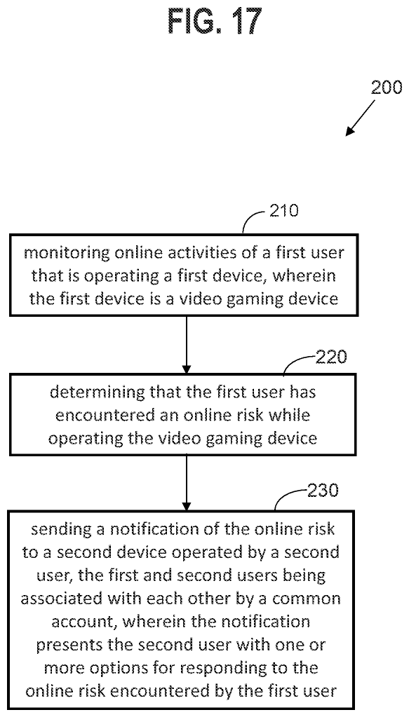

FIG. 17 shows an exemplary embodiment of an exemplary method 200 of monitoring and/or managing online video game play of one or more users. The method 200 includes monitoring online activities of a first user (e.g., a secondary user such as a child) that is operating a video gaming device 110 to play a video game online (step 210).

The method 200 further includes determining that the first user has encountered an online risk while operating the video gaming device (step 220). As pointed out above, this determination can be made by a risk module 150, which may be coupled to or incorporated into the video gaming device 110 or the video gaming server 140 as discussed above. As also discussed above, the risk module 150 may include or be coupled to a generative AI component 160 and a child safety machine learning model 170, which are trained to detect and address potential risks or threats to the safety of secondary users (e.g., children) associated with a given account set up by a primary user. For example, the child safety machine learning model 170 may be designed to analyze text-based and voice-based messages received or sent by a secondary user while using the video gaming device 110 to play online, and to detect content or activities that may be harmful or inappropriate for the secondary user (e.g., by being explicit, violent, threatening, etc.).

In the illustrated embodiment, the method 200 includes sending a notification of the online risk detected by the risk module 150 to have been encountered by the first user (e.g., a secondary user such as Child 1) to a second device (e.g., electronic communication device 180) of a second user (e.g., a primary user of the online gaming monitoring application 190 such as a parent, guardian, etc.) (step 230). As pointed out above, the first user and second users are associated with each other by a common account, and the notification 128 may be visually displayed to the second user on a display screen 182 of the electronic communication device 180 of the second user, and may be interactive to enable the second user to select one or more options for responding to the online risk encountered by the first user.

In view of the foregoing, the systems, graphical user interfaces, applications, and methods described in this application enable parents, guardians, and the like not only to easily and effectively monitor and manage the video game activity of their children, but to also be aware of, and alleviate any active risks that their children may be exposed online while playing video games with other gamers. As such, the safety of children while playing online is increased.

In some embodiments, one or more of the embodiments, methods, approaches, schemes, and/or techniques described above may be implemented in one or more computer programs or software applications executable by a processor-based apparatus or system. By way of example, such processor-based system may comprise a smartphone, tablet computer, virtual reality (VR), augmented reality (AR), or mixed reality (MR) system, entertainment system, game console, mobile device, computer, workstation, gaming computer, desktop computer, notebook computer, server, graphics workstation, client, portable device, pad-like device, communications device or equipment, etc. Such computer program(s) or software may be used for executing various steps and/or features of the above-described methods, schemes, and/or techniques. That is, the computer program(s) or software may be adapted or configured to cause or configure a processor-based apparatus or system to execute and achieve the functions described herein. For example, such computer program(s) or software may be used for implementing any embodiment of the above-described methods, steps, techniques, schemes, or features. As another example, such computer program(s) or software may be used for implementing any type of tool or similar utility that uses any one or more of the above-described embodiments, methods, approaches, schemes, and/or techniques. In some embodiments, one or more such computer programs or software may comprise a VR, AR, or MR application, communications application, object positional tracking application, a tool, utility, application, computer simulation, computer game, video game, role-playing game (RPG), other computer simulation, or system software such as an operating system, BIOS, macro, or other utility. In some embodiments, program code macros, modules, loops, subroutines, calls, etc., within or without the computer program(s) may be used for executing various steps and/or features of the above-described methods, schemes and/or techniques. In some embodiments, such computer program(s) or software may be stored or embodied in a non-transitory computer readable storage or recording medium or media, such as a tangible computer readable storage or recording medium or media. In some embodiments, such computer program(s) or software may be stored or embodied in transitory computer readable storage or recording medium or media, such as in one or more transitory forms of signal transmission (for example, a propagating electrical or electromagnetic signal).

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, schemes, and/or techniques described herein. For example, in some embodiments the present invention provides one or more non-transitory computer readable storage mediums storing one or more computer programs adapted or configured to cause a processor-based apparatus or system to execute steps comprising any one or more of the embodiments, methods, approaches, schemes, and/or techniques described herein.

While the invention herein disclosed has been described by means of specific embodiments and applications thereof, numerous modifications and variations could be made thereto by those skilled in the art without departing from the scope of the invention set forth in the claims.

1. A method comprising:
monitoring online activities of a first user that is operating a first device, wherein the first device is a video gaming device;
determining that the first user has encountered an online risk while operating the video gaming device;
sending a notification of the online risk to a second device operated by a second user; and
receiving, in response to sending the notification, a command from the second device operated by the second user to perform one or more of:
blocking a third user from interacting with the first user,
reporting the third user for inappropriate behavior,
flagging the third user for further review, and
sending a message from the second user to the third user;

2-20. (canceled)

21. The method of claim 1, wherein the online risk comprises an interaction of the first user with the third user, the interaction including at least one of a message, an image, a video, or an audio.

22. The method of claim 1, wherein the determining that the first user has encountered an online risk comprises:
detecting that an interaction between the third user and the first user violates one or more permissions or restrictions.

23. The method of claim 1, wherein the determining that the first user has encountered an online risk comprises:
feeding information relating to online activity of the first user while the first user is operating the video gaming device into an artificial intelligence model trained to recognize the online risk to the first user.

24. The method of claim 1, wherein the notification further includes a description of the online risk or content associated with the online risk.

25. The method of claim 1, wherein the notification is transmitted from a video gaming server to a mobile application installed on the second device, and wherein the notification is displayed within a graphical interface generated by the mobile application.

26. The method of claim 1, wherein the command is other than a command to retrain a model, block the first user, or ignore the online risk.

27. A system comprising:
one or more computer processors; and
one or more non-transitory computer-readable media that store instructions which, when executed, cause the one or more computer processors to perform operations comprising:
monitoring online activities of a first user that is operating a first device, wherein the first device is a video gaming device;
determining that the first user has encountered an online risk while operating the video gaming device;
sending a notification of the online risk to a second device operated by a second user; and
receiving, in response to sending the notification, a command from the second device operated by the second user to perform one or more of:
blocking a third user from interacting with the first user,
reporting the third user for inappropriate behavior,
flagging the third user for further review, and
sending a message from the second user to the third user.

28. The system of claim 27, wherein the online risk comprises an interaction of the first user with the third user, the interaction including at least one of a message, an image, a video, or an audio.

29. The system of claim 27, wherein the determining that the first user has encountered an online risk comprises:
detecting that an interaction between the third user and the first user violates one or more permissions or restrictions.

30. The system of claim 27, wherein the determining that the first user has encountered an online risk comprises:
feeding information relating to online activity of the first user while the first user is operating the video gaming device into an artificial intelligence model trained to recognize the online risk to the first user.

31. The system of claim 27, wherein the notification further includes a description of the online risk or content associated with the online risk.

32. The system of claim 27, wherein the notification is transmitted from a video gaming server to a mobile application installed on the second device, and wherein the notification is displayed within a graphical interface generated by the mobile application.

33. The system of claim 27, wherein the command is other than a command to retrain a model, block the first user, or ignore the online risk.

34. A non-transitory computer readable storage medium storing one or more computer instructions which, when executed by one or more computer processors, cause the one or more computer processors to perform operations comprising:
monitoring online activities of a first user that is operating a first device, wherein the first device is a video gaming device;
determining that the first user has encountered an online risk while operating the video gaming device;
sending a notification of the online risk to a second device operated by a second user; and
receiving, in response to sending the notification, a command from the second device operated by the second user to perform one or more of:
blocking a third user from interacting with the first user,
reporting the third user for inappropriate behavior,
flagging the third user for further review, and
sending a message from the second user to the third user.

35. The medium of claim 35, wherein the determining that the first user has encountered an online risk comprises:
detecting that an interaction between the third user and the first user violates one or more permissions or restrictions.

36. The medium of claim 35, wherein the determining that the first user has encountered an online risk comprises:
feeding information relating to online activity of the first user while the first user is operating the video gaming device into an artificial intelligence model trained to recognize the online risk to the first user.

37. The medium of claim 35, wherein the notification further includes a description of the online risk or content associated with the online risk.

38. The medium of claim 35, wherein the notification is transmitted from a video gaming server to a mobile application installed on the second device, and wherein the notification is displayed within a graphical interface generated by the mobile application.

39. The medium of claim 35, wherein the command is other than a command to retrain a model, block the first user, or ignore the online risk.
